(19) United States
(12) Patent Application Publication
(10) Pub. No.: US 2014/0064446 A1
(43) Pub. Date: Mar. 6, 2014

(54) X-RAY ABSORPTIOMETRY USING SOLID-STATE PHOTOMULTIPLIERS

(71) Applicants: James A. Wear, Madison, WI (US); Sergei Dolinsky, Clifton Park, NY (US); Randall Payne, Madison, WI (US); Ravindra Mohan Manjeshwar, Glenville, NY (US)

(72) Inventors: James A. Wear, Madison, WI (US); Sergei Dolinsky, Clifton Park, NY (US); Randall Payne, Madison, WI (US); Ravindra Mohan Manjeshwar, Glenville, NY (US)

(73) Assignee: GENERAL ELECTRIC COMPANY, Schenectady, NY (US)

(21) Appl. No.: 13/605,493

(22) Filed: Sep. 6, 2012

(51) Int. Cl. G01T 1/20; G01N 23/04

(52) U.S. Cl. 378/62; 250/367; 250/366

(57) ABSTRACT

An x-ray absorptiometry apparatus and method utilize a radiation source having a beam opening angle of less than or equal to 30 milliradians in at least one dimension, an array of scintillator units to receive radiation from the radiation source with the beam angle after the radiation has passed through a body being imaged and at least one solid-state photomultiplier to receive photons from the array of scintillator units and to produce electrical signal based on the photons. In one implementation, an optical area transmission passage modifier is employed in a dual energy x-ray absorptiometry system. In one implementation, the array of scintillator units are arranged in staggered rows. In yet another implementation, the solid-state photomultiplier includes a plurality of solid-state photomultipliers arranged in rows. In one implementation, a single solid-state photomultiplier receive photons from a plurality of scintillators of the array.

### CROSS-REFERENCE TO RELATED PATENT APPLICATIONS

The present application is related to co-pending U.S. patent application Ser. No. ______ filed on the same date herewith by James A. Wear, Sergei I. Dolinsky and Ravindra Mohan Manjeshwar and entitled ENHANCED RESPONSE OF SOLID STATE PHOTOMULTIPLIER TO SCINTILLATOR LIGHT BY USE OF WAVELENGTH SHIFTERS, the full disclosure of which is hereby incorporated by reference.

### BACKGROUND

X-ray absorptiometry systems are frequently utilized in bone densitometry, body composition, baggage scanning and other applications that rely on material decomposition. X-ray absorptiometry systems typically utilize room temperature semiconductors for counting photons. In addition to being expensive to grow and package, such semiconductors lack intrinsic amplification and may require low noise-high gain front-end application. Such semiconductors are further prone to polarization effects which may require signal compensation or occasional bias cycling. Other X-ray absorptiometry systems utilize a single scintillating crystal and conventional photomultiplier tube for counting photons. Such systems are limiting to single channel operation which are slower than array-based systems.

### BRIEF DESCRIPTION OF THE INVENTION

An example x-ray absorptiometry apparatus comprises a radiation source having a beam opening angle of less than or equal to 30 milliradians in at least one dimension, an array of scintillator units to receive radiation from the radiation source with the beam angle after the radiation has passed through a body being imaged and an array of solid-state photomultipliers to receive photons from the scintillator and to produce electrical signal based on the photons. This signal may be based on counted photons or sensed electrical current.

An example x-ray absorptiometry apparatus comprises a plurality of scintillators and a solid-state photomultiplier receiving photons from the plurality of scintillators.

An example x-ray absorptiometry apparatus comprises a plurality of scintillators and a plurality of solid-state photomultipliers receiving photons from the plurality of scintillators. At least one of the plurality of scintillators and the plurality of solid-state photomultipliers is arranged in staggered rows.

An example method comprises providing a beam of ionizing radiation having a beam opening angle of less than or equal to 30 milliradians in at least one dimension, receiving the ionizing radiation that has passed through a body being imaged with an array of scintillator units, converting absorbed energy in the scintillator units into photons and receiving the photons with the solid-state photomultiplier to produce an electrical signal.

### BRIEF DESCRIPTION OF THE DRAWINGS

FIG. 1 is a schematic illustration of an example x-ray absorptiometry device.

FIG. 2 is a schematic illustration of an example imaging system including the x-ray absorptiometry device of FIG. 1.

FIG. 3 is a flow diagram of an example method that may be carried out by the x-ray absorptiometry device of FIG. 1.

FIG. 4 is a schematic illustration of an example implementation of the x-ray absorptiometry device FIG. 1.

FIG. 5 is a schematic illustration of another example implementation of the x-ray absorptiometry device of FIG. 1.

FIG. 6 is a schematic illustration of another example implementation of the x-ray absorptiometry device of FIG. 1.

FIG. 7 is a schematic illustration of another example implementation of the x-ray absorptiometry device of FIG. 1.

FIG. 8 is a schematic illustration of an example imaging system including the x-ray absorptiometry device of FIG. 1.

FIG. 9 is a schematic illustration of an example implementation of a radiation detector that may be used in the x-ray absorptiometry device of FIG. 1.

FIG. 10 is a schematic illustration of another example implementation of the radiation detector that may be used in the x-ray absorptiometry device of FIG. 1.

FIG. 11 is a schematic illustration of another example implementation of the radiation detector that may be used in the x-ray absorptiometry device of FIG. 1.

FIG. 12 is a schematic illustration of another example implementation of the radiation detector that may be used in the x-ray absorptiometry device of FIG. 1.

FIG. 13 is a schematic illustration of another example implementation of the radiation detector that may be used in the x-ray absorptiometry device of FIG. 1.

FIG. 14 is a schematic illustration of another example implementation of the radiation detector that may be used in the x-ray absorptiometry device of FIG. 1.

FIG. 15 is a schematic illustration of another example implementation of the radiation detector that may be used in the x-ray absorptiometry device of FIG. 1.

FIG. 16 is a schematic illustration of another example implementation of the radiation detector that may be used in the x-ray absorptiometry device of FIG. 1.

FIG. 17 is a schematic illustration of another example implementation of the radiation detector that may be used in the x-ray absorptiometry device of FIG. 1.

### DETAILED DESCRIPTION OF THE EXAMPLE EMBODIMENTS

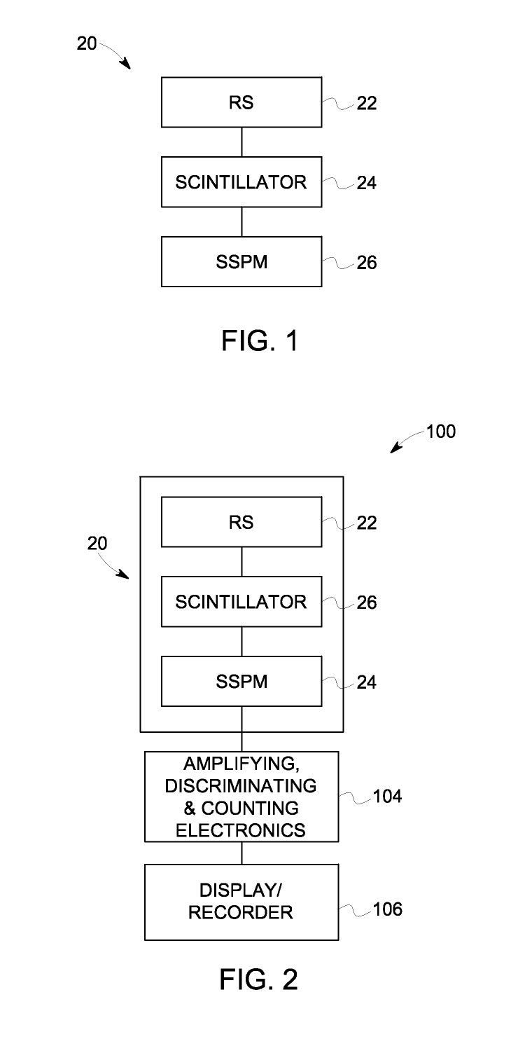

FIG. 1 schematically illustrates an example x-ray absorptiometry device 20. X-ray absorptiometry device 20 may be employed in various applications such as imaging systems and the like. X-ray absorptiometry device 20 uses an array of scintillator units to convert radiation received through a beam having an opening angle of less than 30 milliradians in at least one dimension into photons or light which is sensed by at least one solid state photomultiplier to produce an electrical signal. As a result, device 20 may be more reliable and less costly.

X-ray absorptiometry device 20 comprises radiation source 22, scintillator 24 and solid-state photomultiplier 26. Radiation source 22 comprises a source of ionizing radiation which directs such ionizing radiation through, across and around a body being imaged by system 100. For purposes of this disclosure, the term “body” shall mean any animate or inanimate structure being imaged by system 100, including both living and nonliving structures or organisms. Radiation source 22 provides radiation in the form of a narrow beam, a beam having an opening angle of less than 30 milliradians in at least one dimension. In one implementation, radiation source 22 has an opening beam angle of less than or equal to 25 milliradians. In the example illustrated, radiation source 22 has a beam opening angle of less than or equal to 25 milliradians in at least one dimension and nominally less than or equal to 10 milliradians in at least one dimension. Because radiation source provides radiation in such a narrow beam, beam scattering is reduced, facilitating more accurate absorptiometry measurements. In one implementation, radiation source 102 comprises a source of x-rays. In other implementations, radiation source 102 may comprise a source of other rays which may excite scintillator 24 of absorptiometry device 20, such as gamma rays.

In one implementation, imaging system 100 comprises a dual energy x-ray absorptiometry device (DEXA or DXA system) in which signals produced from radiation from source 22 are assigned into bins based on energy levels. In the example illustrated, The signals received from solid-state photomultiplier (SSPM) 26 of absorptiometry device 20 are categorized into two corresponding bins: (1) a first bin comprising those signals between 20 and 50 KeV (originating from the 20 KeV level) and (2) a second bin comprising those signals between 50 and 76 KeV (originating from the 76 KeV level). The difference in the number of signals in each of the bins is then used, using various formulations and mathematics, to quantify how much bone mineral is in the path of the x-ray (bone mineral density). Additional details regarding such exemplary bone density detection may be found in co-pending U.S. patent application Ser. No. 12/557,314 filed on Sep. 10, 2009 by Wear et al (published as US Patent Publication 2011/0058649), the full disclosure of which is hereby incorporated by reference.

In other implementations, other energy levels or a different number of energy levels may be supplied by radiation source 22 in other manners. For example, in other implementations, radiation source 22 may comprise a switching radiation source in which source 22 alternately provides the two energy levels of radiation. For example the current generated during a low energy exposure by the switching radiation source may be measured the SSPM 26. Similarly, during the high energy exposure by the switching radiation source, the current may be measured by the SSPM 26. The sensed or measure current during the sequential exposures may be used to carry out the same absorptiometry measurements or imaging as the photon counting implementation described above. In other implementations, device 20 may be used for other purposes and may include other configurations for radiation source 22 and electronics 104.

Scintillator 24 comprises a material that exhibits scintillation, the property of luminescence when excited by ionizing radiation. In response to receiving or being impinged by ionizing radiation, such as x-rays or gamma rays, scintillator 24 converts the received ionizing radiation (the incident rays of radiation) into photons or light which is subsequently emitted from scintillator 24. Scintillator 24 directs the emitted photons or light towards solid-state photomultiplier 26 through optical area constrictor 26. In one implementation, scintillator 24 includes one or more reflective surfaces on its outer periphery that direct or guide the produced photons through optical area constrictor 26 towards the solid-state photomultiplier 24.

In one example implementation, scintillator 24 comprises a crystal of one or more scintillation materials that are relatively fast, dense and bright. Examples of such scintillation materials include, but are not limited to, Lu1.8Y0.2SiO5:Ce (LYSO), Lu2SiO5:Ce (LSO), NaI:Tl, Gd2SiO5:Ce (GSO), LaBr3:Ce; YAP, LuAp, and BaF2. When formed from such scintillation materials, scintillator 24 converts incident x-rays into optical photons. In switched energy mode, SSPM's may be used to generate photocurrent signals with these scintillators and slower, bright scintillators such as: CsI(Tl), CsI, CsI(Na), CdWO4. [0029] Solid-state photomultiplier 26 (also referred to as a silicon photomultiplier or SIPM) comprises a device configured to sense photons and to produce an electrical signal in response to such photons. In particular, Solid-state photomultiplier 26 absorbs the photons or light emitted by scintillator 24 and further passing through optical area constrictor 26, wherein solid-state photomultiplier 26 emits electrons via the photoelectric effect. The multiplication of electrons (photo-electrons) by solid-state photomultiplier 26 produces an electrical pulse which may be subsequently analyzed for information about the particle or radiation that originally struck scintillator 24 As will be described hereafter, in one example implementation, such electrical signals output by photomultiplier 24 are counted or otherwise analyzed to produce an image. In another implementation, the electrical current of such signals is measured to produce an image. Examples of solid-state photomultiplier 26 include, but are not limited to, a silicon photomultiplier or Geiger mode avalanche photodiode.

Optical area constrictor 26 comprises an optical area transmission passage modifier. Optical area constrictor 26 comprises one or more structures or one or more materials optically coupled between and to each of scintillator 24 and solid-state photomultiplier 26 that match the output and input cross-sectional areas of scintillator 24 and solid-state photomultiplier 24, facilitating the use of solid-state photomultipliers 24 with scintillators 22 for enhanced image resolution and for enhanced photon counting (when used in a dual energy x-ray system). In the example illustrated, optical area constrictor 26 constricts an area through which photons are transmitted or through which such photons pass from scintillator 24 to solid-state photomultiplier 24. In some implementations in which the output area of scintillator 24 is smaller than the input area of photomultiplier 24, an alternative optical area transmission passage modifier may be utilized which enlarges, rather than constricts, the cross-sectional area of the transmission or optical passage between scintillator 24 and solid-state photomultiplier 24. For purposes of this disclosure, the term or phrase “optically coupled” shall mean that the two components that are “optically coupled” are arranged such that photons emitted by one component are guided or directed to the other component, either through direct contact between the components or through one or more intermediate mediums such as through an empty space, a liquid filled space or a gas filled space, an optical transmission structure such as a lens or light guide, or a compound, whether be solid, semisolid or fluid. Such optical coupling may result in the direct transmission of photons or the reflected transmission of photons using one or more reflective surfaces.

As will be described hereafter, in one implementation, optical area constrictor may comprise a tapered light guide through which photons are transmitted. In another implementation, optical area constrictor 26 may comprise reflective surfaces that form a size constricted window through which photons are transmitted. By constricting the size of the transmission area or passage through which such photons pass to solid-state photomultiplier 24, optical area constrictor 26 enables solid-state photomultiplier 26 to have an inlet or input with a photon receiving area that is smaller as compared to the photon emitting area of scintillator 24. As a result, solid-state photomultiplier 26 may be smaller relative to the size of scintillator 24, reducing the cost of x-ray absorptiometry device 20.

FIG. 2 schematically illustrates an example imaging system 100 including x-ray absorptiometry device 20. In addition to x-ray absorptiometry device 20, imaging system 100 comprises amplifying, discriminating and counting electronics 104 and display/recorder 106.

Electronics 104 comprise electronics that receive the microcell electrical pulses or electrical signals from solid-state photomultiplier 26 of absorptiometry device 20. In the example illustrated, electronics 104 amplifies such signals, discriminates such signals and counts such signals. In one implementation, electronics 104 includes a buffer amplifier to amplify the electrical signals. In one implementation, electronics 104 further includes discriminators that compare a voltage of a signal to a predefined threshold voltage to determine whether the signal being received is the result of the reception of a photon by solid-state photomultiplier 26 or is due to noise. Those signals that are determined to have a voltage greater than a threshold voltage are counted by electronics 104.

Display/recorder 106 receives the counted values for such signals and utilizes such values to generate or produce an image. In one implementation, display/recorder 106 includes a monitor or display screen on which the image is visually displayed for viewing. In one implementation, display/recorder 106 includes a recordation device to record the produce images. Examples of such a recordation device include a printer or a persistent storage device such as a flash memory, optical disk, magnetic disk or tape or other memory device. In one implementation, display/recorder 106 may include both a display and a recordation device. In one implementation, electronics 104 and display/recorder 106 may be part of a self-contained unit. In yet other implementations, display/recorder 106 may be remote, receiving signals from electronics 104 in a wired or wireless fashion across a network.

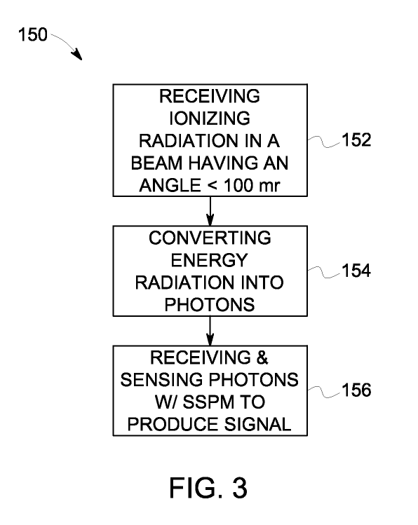

FIG. 3 is a flow diagram illustrating an example method 150 which may be carried out by the imaging system 100 of FIG. 2. As indicated by step 152, scintillator 24 of absorptiometry device 20 receives ionizing radiation in a beam having a beam opening angle of less than or equal to 30 milliradians in at least one dimension supplied by radiation source 22 after the beam has passed through, around and across a body being imaged. As indicated by step 154, in response to being impinged by such ionizing radiation, scintillator 24 converts the energy of the radiation into optical photons.

As indicated by step 156, optical area constrictor 26 constricts the optical transmission cross-sectional area between scintillator 24 and solid-state photomultiplier 24. Optical area constrictor 26 receives photons through a photon emitting area of scintillator 24 and narrows down, reduces in size or otherwise constricts the cross-sectional area through which such photons pass from the photon emitting area to a smaller photon receiving area of solid-state photomultiplier 24. As noted above, by reducing the transmission cross-sectional area between scintillator 24 and solid-state photomultiplier 24, constrictor 26 facilitates the combination of a larger scintillator with a smaller solid-state photomultiplier lowers the overall cost of absorptiometry device 20 and the overall cost of imaging system 100.

As indicated by step 156, solid-state photomultiplier 26 receives such photons and senses such photons to produce electrical pulses or electrical signals. As noted above, in the particular implementation shown in FIG. 2, such electrical signals produced by absorptiometry device 20 are further amplified, discriminated and counted to generate an image that is displayed and/or recorded.

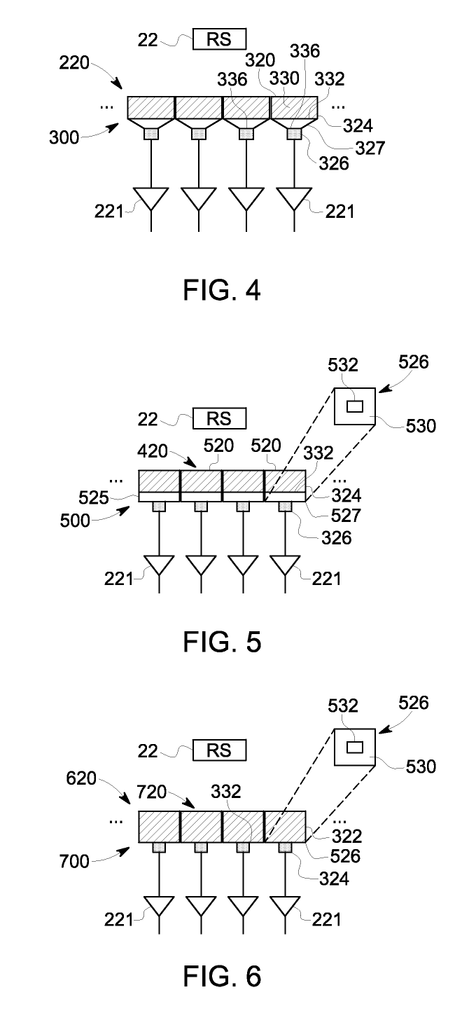

FIG. 4 schematically illustrates device 220, an example of absorptiometry device 20. As shown by FIG. 4, device 220 is similar to device 20 except that device 220 further comprises buffer amplifiers 221 and optical area constrictor 327. Buffer amplifiers 221 amplify the signals outputted from device 220 prior to such signals being discriminated and counted by electronics. Device 220 comprises an array 300 of detector cells or detector units 320. Each detector unit 320 comprises scintillator 324, solid state photomultiplier 326 and optical area constrictor 327.

Scintillator 324 is similar to scintillator 24 described above. In the example illustrated, scintillator 324 comprises a body of scintillation material surrounded by reflective surfaces but for a photon emitting area. In the example illustrated in which scintillator 324 is depicted as a six sided rectangle, scintillator 324 includes five reflective faces 330, the four sides and the top, and a lower or bottom face 332 (omitting any reflective material) serving as the photon emitting area of scintillator 320. The reflective faces may be formed by coatings of materials that are spectrally opaque to the wavelength of the scintillator light or photons produced by scintillator 324.

In one implementation, the reflective faces maybe formed by white paint, such as titanium oxide. In other implementations, the reflective faces may be formed by other reflective material such as polytetrafluoroethylene (TEFLON) tape, white plastics, white epoxies, reflective metals, glues and the like. In other implementations, scintillator 324 may have other shapes with other configurations or material compositions for the reflective surfaces that define or form the photon emitting area of the scintillator 324.

Solid-state photomultiplier 326 is similar to solid-state photomultiplier 26 described above. Solid-state photomultiplier 326 comprises an input 336 through which photons produced by scintillator 324 are received and absorbed by photomultiplier 326. Input 336 has a cross sectional area forming a photon receiving area for photomultiplier 326. Although input 336 has a face with the cross-sectional area that itself faces scintillator 324, in other implementations, input 336 may not directly face scintillator 324 or may not directly face photon emitting area 332 of an output of scintillator 324 where light guides, lenses, mirrors, reflective surfaces of the like optically couple solid-state photomultiplier 326 to scintillator 324 and where such optical coupling devices turn or redirect the light photons between scintillator 324 and photomultiplier 326.

As shown by FIG. 4, the photon receiving area of input 336 has at least one dimension less than a corresponding dimension of photon emitting area 332. In the example illustrated, input 336 has a photon receiving cross-sectional area that is less than the cross-sectional photon emitting area of scintillator 324. Solid-state photomultiplier 326 has a size that is less than the size of scintillator 324, reducing the cost of device 220.

Optical area constrictor 327 comprises a structure optically coupled between and to each of scintillator 324 and solid-state photomultiplier 326 that constricts an area through which photons are transmitted or through which such photons pass from scintillator 324 to solid-state photomultiplier 326. In the example illustrated, optical area constrictor 327 comprises a tapering or tapered light guide. Optical area constrictor 327 constricts the optical transmission area by serving as a light guiding funnel which funnels photons from the wider or larger photon emitting area 332 of scintillator 324 down to the narrower or smaller photon receiving area of input 336 of solid-state photomultiplier 326.

In the example illustrated, optical area constrictor 327 has an input side directly connected to scintillator 324 and output side directly connected to solid-state photomultiplier 326. In other implementations, other light directing, light channeling or light guiding structures may be interposed between scintillator 324 and constrictor 327 and/or between constrictor 327 and solid-state photomultiplier 326. For example, empty, liquid filled or gas filled spaces, lenses or other light pipes may be interposed on either side of constrictor 326.

In one example implementation, the light guide forming constrictor 327 comprises a light guide additionally configured to shift a wavelength of photons emitted by scintillator 324 prior to emitting the wavelength shifted photons to solid-state photomultiplier 326. The light guide forming constrictor 327 shifts the wavelength of the photons received from scintillator 324 to a different wavelength at which solid-state photomultiplier 326 has an enhanced photon detection efficiency. In such an example, solid-state photomultiplier 326 converts photons to electrons at a quantum efficiency characteristic of the material or construction of photomultiplier 326. Solid-state photomultiplier 326 has a maximum quantum efficiency when receiving photons having an optimal wavelength. In one implementation, the optimal wavelength of a photon at which solid-state photomultiplier 326 converts the photon to an electron or electrical signal has a wavelength between 450 nm and 600 nm. In one implementation, the quantum efficiency of solid-state photomultiplier 326 exhibits a bell curve with the peak of the bell curve occurring at the optimal wavelength of 500 nm (green light) or thereabouts. In one implementation, solid-state photomultiplier 326 has a photon detection efficiency of between 4% and 5% when receiving photons having a peak wavelength of around 420 nm and a photon detection efficiency of about 14% when receiving photons having a peak wavelength of about 500 nm.

In one example implementation, the light guide forming constrictor 327 upwardly shifts the wavelength of the photons received from scintillator 324. In one implementation, the light guide forming constrictor 327 receives photons having a peak wavelength of less than 450 nm (nominally 420 nm; the blue light being emitted by scintillator 24) and isotropically re-emits the same photons with the wavelength of at least 450 nm and less than or equal to about 600 nm (nominally 500 nm within a range of green light (480 nm to 600 nm).

In the example illustrated, the wavelength shifting material transmits photons from an input side of the material to an output side of the material along and about a straight linear path. For purposes of this disclosure, any phrases referring to the transmission of photons by the wavelength shifting material from an input side to an output side along and about a straight linear path means that wavelength shifted light is directed along a path largely normal to the primary light emission face of the scintillator. In one implementation, the input side and the output side are oriented such that a single linear (straight) axis may intersect the input side and the output side without exiting the body of the wavelength shifting material between such sides. During the transmission of photons within the wavelength shifting material, such photons may travel along nonlinear paths or paths consisting of multiple non-parallel linear segments; however, the wavelength shifted light is still directed along or about a path largely normal to the primary light emission face of the scintillator. Although the wavelength of photons are sometimes shifted for the sole purpose of facilitating steering of the photons through bends and turns of a wavelength shifting material, such as through a bent or turning light pipe, in such applications, because the wavelength shifting material itself bent or is intended to turn, photons are not transmitted by the wavelength shifting material from an input side to an output side along a straight linear path as defined in the present disclosure. Because the wavelength shifting material shifts the wavelength of photons while such photons are transmitted from an input side to an output side along and about a straight linear path, the photons may be more efficiently transmitted and the detector may be more compact. In one implementation, wavelength shifting material comprises a wavelength shifting light guide. In another implementation, the wavelength shifting material may comprise a wavelength shifting compound.

FIG. 5 schematically illustrates device 420, an example of absorptiometry device 20. Device 420 comprises an array 500 of detector cells or detector units 520. Each detector unit 520 comprises scintillator 324, solid state photomultiplier 325, light guide 525 and optical area constrictor 527.

Scintillator 324 and solid-state photomultiplier 326 are described above with respect to device 220. Solid-state photomultiplier 326 has a photon receiving or photon absorbing input cross-sectional area that is less than the photon emitting area of scintillator 324. In the example illustrated, solid-state photomultiplier 326 has a size that is less than the size of scintillator 324, reducing the cost of device 220.

Light guide 525 is optically coupled between scintillator 324 and solid-state photomultiplier 326. For purposes of this disclosure, the term or phrase “optically coupled” shall mean that the two components that are “optically coupled” are arranged such that photons emitted by one component are guided or directed to the other component, either through direct contact between the components or through one or more intermediate mediums such as through an empty space, a liquid filled space or a gas filled space, an optical transmission structure such as a lens or light guide, or a compound, whether be solid, semisolid or fluid. Such optical coupling may result in the direct transmission of photons or the reflected transmission of photons using one or more reflective surfaces. Light guide 525 guides or directs light from the photon emitting area 332 to optical area constrictor 527. Unlike the light guide forming optical area constrictor 327, light guide 526 does not funnel light photons.

Optical area constrictor 527 constricts the cross-sectional optical transmission area between scintillator 326 and solid-state photomultiplier 326. Optical area constrictor 527 comprises reflective surfaces 530 surrounding or otherwise defining or forming a window 532 through which photons may pass. The reflective surfaces may be formed by coatings of materials that are spectrally opaque to the wavelength of the scintillator light or photons produced by scintillator 324. In one implementation, the reflective surfaces or reflective surface may be formed by white paint, such as titanium oxide. In other implementations, the reflective faces may be formed by other reflective material such as polytetrafluoroethylene (TEFLON) tape, white plastics, white epoxies, reflective metals, glues and the like. In example illustrated, optical area constrictor 527 is formed on an output end of light guide 525.

FIG. 6 schematically illustrates detector 620, an example of absorptiometry device 20. FIG. 5 further illustrates detector 620 supplying signals to buffer amplifiers 221 which amplify the signals outputted from detector 620 prior to such signals being discriminated and counted by electronics. Detector 620 comprises an array 700 of detector cells or detector units 720. Each detector unit 720 comprises scintillator 324, solid state photomultiplier 325 and optical area constrictor 527. Overall, each detector unit 720 is similar to the aforementioned detector unit 520 except that each detector unit 720 omits light guide 525 optically coupled between scintillator 324 and solid-state photomultiplier 326. Instead, as shown by FIG. 6, optical area constrictor 527 is formed directly upon the photon emitting face 332 of scintillator 324 between scintillator 324 and solid-state photomultiplier 326.

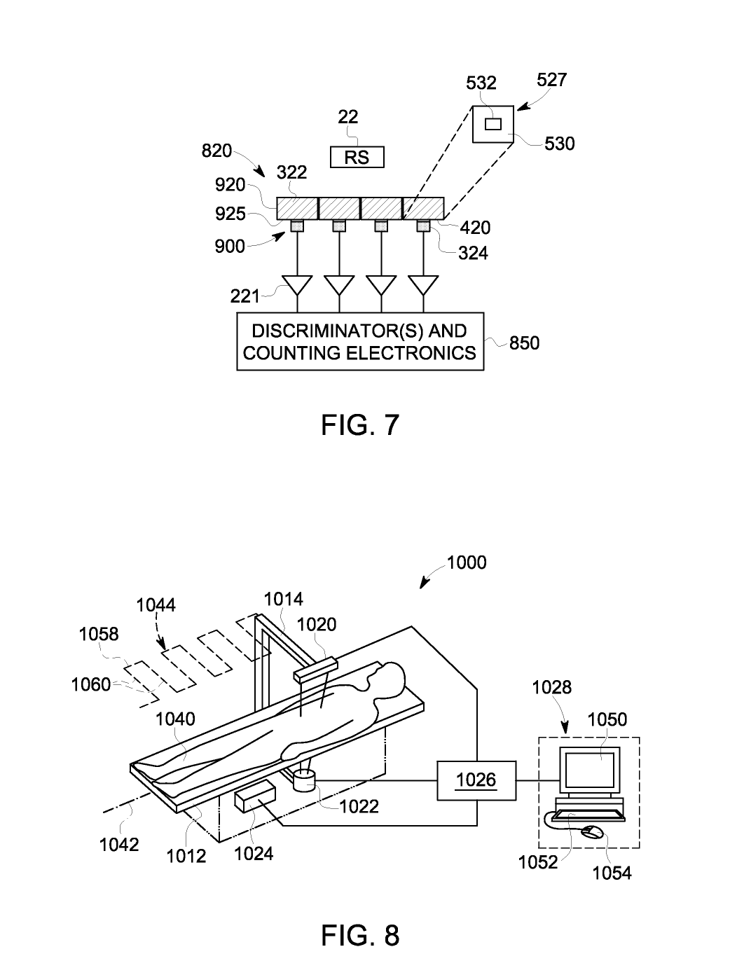

FIG. 7 schematically illustrates device 820, an example of absorptiometry device 20. FIG. 7 further illustrates device 820 supplying signals to buffer amplifiers 221 which amplify the signals outputted from detector 620 prior to such signals being discriminated and counted by electronics 850. Device 820 comprises an array 900 of detector cells or detector units 920. Each detector unit 920 comprises scintillator 324, solid state photomultiplier 325, light guide 925 and optical area constrictor 527. Overall, each detector unit 920 is similar to the aforementioned detector unit 720 except that each detector unit 720 additionally comprises a light guide 925 optically coupled between optical area constrictor 527 and solid-state photomultiplier 326. Light guide 925 is similar to light guide 525 except that light guide 925 is located optically between optical area constrictor 526 and solid-state photomultiplier 324. Because light guide 925 is between optical area constrictor 527 and solid-state photomultiplier 326, light guide 925 receives photons from scintillator 324 through a path that has already been constricted by constrictor 527. As a result, light guide 925, like solid-state photomultiplier 326, may have a reduced cross-sectional area or a reduced input area.

In one implementation, light guide 925 may be additionally configured to shift the wavelength of the photons emitted by scintillator 324 prior to such photons being remitted towards solid-state photomultiplier 326 as described above. In other implementations, light guide 925 may be omitted. In yet other implementations, and optical coupling compound may be optically coupled between scintillator 324 and solid-state photomultiplier 326. Such an optical coupling compound may itself be additionally configured to shift wavelength of the photons emitted by scintillator 324 prior to re-emitting the wavelength shifted photons towards solid-state photomultiplier 326. Such an optical coupling compound may comprise an epoxy including wavelength shifting dopants. Such an optical coupling compound may be configured to shift wavelength in a fashion similar to the wavelength shifting performed by the light guides 525 or light guides 925 as described above.

Electronics 850 receive electronic signals from solid-state photomultipliers 326, after such signals have further been buffered and amplified by amplifiers 221. Electronics 850 comprise discriminators that compare a voltage of a signal to a predefined threshold voltage to determine whether the signal being received is the result of the reception of a photon by solid-state photomultiplier 326 or is due to noise. Those signals that are determined to have a voltage greater than a threshold voltage are counted by electronics 850.

FIG. 8 illustrates imaging system 1000, an example implementation of imaging system 100. In one implementation, imaging system 1000 comprises a dual x-ray absorptiometry (DEXA or DXA) system. In other implementations, system 1000 may be utilized for other purposes and may have other configurations. Imaging system 1000 comprises patient table 1012, support 1014, detector 1020, radiation source 1022, translation drive 1024, interface device 1026 and controller 1028. Patient table 1012 comprises a structure providing them horizontal surface for supporting a subject, for example, a patient 1040, in a supine or lateral position along a longitudinal axis 1042.

Support 1014 comprises a structure configured to support detector 1020. In the example implementation, support 1014 further supports radiation source 1022. Support 1014 is operably coupled to translation drive 1024 such that support 1014, along with detector 1020 and radiation source 1022, may be incrementally moved along a scanning path 1044. In other implementations where the subject or object being imaged is smaller where a particular defined region of the subject object is to be imaged, support 1014 may alternatively stationarily support detector 1020, wherein translation drive 1024 is omitted.

Detector 1020 detects radiation, such as x-rays, that is passed through patient 1040. Detector 1020 comprises an implementation of absorptiometry device 20 described above. In some implementations, detector 1020 comprises an implementation of any of detectors 220, 420, 620 and 820.

Radiation source 1022 directs radiation through table 1012 through patient 1042 towards detector 1020. Radiation source 1020 comprises an implementation of radiation source 22. As noted above, radiation source 22 provides radiation in the form of a narrow beam, a beam having an opening angle of less than 30 milliradians in at least one dimension. In one implementation, radiation source 22 has an opening beam angle of less than or equal to 25 milliradians in at least one dimension. In the example illustrated, radiation source 22 has an opening beam angle of less than or equal to 25 milliradians and nominally less than or equal to 10 milliradians in at least one dimension. Because radiation source provides radiation in such a narrow beam, beam scattering is reduced, facilitating more accurate absorptiometry measurements. In one implementation, radiation source 102 comprises a source of x-rays. In other implementations, radiation source 102 may comprise a source of other rays which may excite scintillator 24 of absorptiometry device 20, such as gamma rays.

Interface device 1028 comprises a device by which data or information produced from the signals received from detector 1020 are stored, presented or provided to a person. In the example illustrated, interface device 1028 comprises a monitor 1050 and input devices 1052 and 1054. Monitor 1050 comprises a screen by which the results from imaging system 1000 may be displayed. Input devices 1052 and 1054, illustrated as comprising a keyboard and a mouse, respectively, comprise devices by which a person may enter instructions, commands or selections as to how data should be presented on monitor 1050, as to where or how such data should be stored and as to the particular operation of imaging system 1000. In other implementations, interface device 1028 may have other configurations, including other display devices and other input devices.

Controller 1026 comprises one or more processing units configured to receive signals from detector 1020, to process such signals to produce data or information, to generate control signals displaying or storing the raw signals and/or the produced data and to generate control signals directing the operation of imaging system 1000, such as the operation of radiation source 1022 and drive 1024. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry or electronics may be used in place of or in combination with software instructions to implement the functions described. For example, controller 1026 may be embodied as part of one or more application-specific integrated circuits (ASICs). Unless otherwise specifically noted, the controller is not limited to any specific combination of hardware circuitry and software, nor to any particular source for the instructions executed by the processing unit. In the example illustrated, controller 126 (which is schematically illustrated) may be embodied as part of a single computing system which also provides monitor 1050 and inputs 1052, 1054. In other implementations, controller 126 may be implemented as a separate control unit distinct from the illustrated computing system. In some implementations, controller 126 may be implemented in several modules or separate units.

Imaging system 1000 may carry out the method 150 described above with respect to FIG. 3. In one implementation, in response to receiving input instructions through input 1052 or 1054, controller 1026 generate control signals directing radiation source 1022 to direct radiation through patient 1040 towards detector 1020. During such movement, controller 1026 further generates control signals directing drive 1024 to move radiation source 1022 and detector 1020 in a raster pattern 1058 so as to trace a series of transverse scans 1060 of patient 1040. Another implementation allows raster sweeps in longitudinal directions. Other implementations allow a single sweep in either the transverse or longitudinal directions.

During such scans, energy x-ray data is collected by detector 1020. In particular, scintillator 24, 322 receives ionizing radiation and converts the energy or radiation into photons. The photons emitted by scintillator 24, 322 are passed through a constricted optical transmission area to solid-state photomultiplier 24, 324 which produces logical signals. As noted above, in one implementation, the wavelengths of such photons may further be shifted between scintillator 24, 322 and photomultiplier 24, 324 to enhance the photon detection efficiency of detector 1020.

The electrical signals produced by detector 1020 are amplified, discriminated and counted by electronics associated with controller 1026. Such counted signals are then utilized to produce an image of patient 1040. The image is stored and/or displayed on monitor 1050. As noted above, in one implementation, multiple levels of x-ray energy may be provided by source 1022 to perform dual energy x-ray absorptiometry for acquiring such data as bone density. In other implementations, imaging system 1000 may have other configurations and may perform other methods.

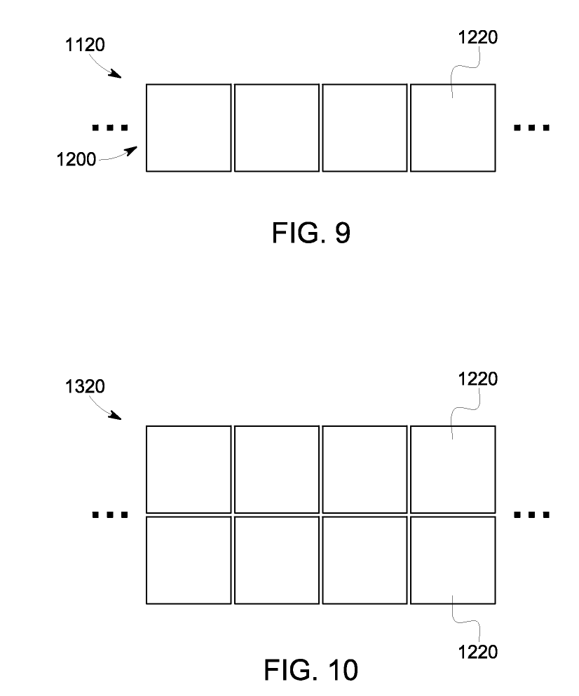

FIG. 9 schematically illustrates detector 1120 for use with radiation source 22, 1022. Detector 1120 comprises a one-dimensional array or row 1200 of detector units 1220. In one implementation, detector units 1220 comprise detector units 920 as described above. In another implementation, detector unit 1220 comprises detector units 720 or detector units 520 or detector units 320 as described above.

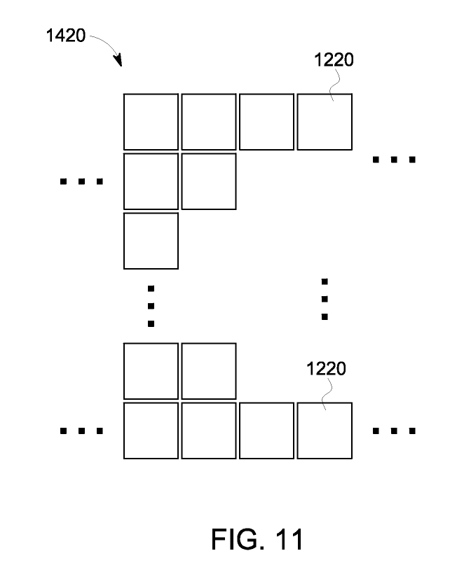

FIG. 10 schematically illustrates detector 1320 for use with radiation source 22, 1022. Detector 1320 comprises a two-dimensional array of two rows of detector units 1220. FIG. 11 illustrates detector 1420. Detector 1420 comprises a two-dimensional array of n-rows of detector units 1220.

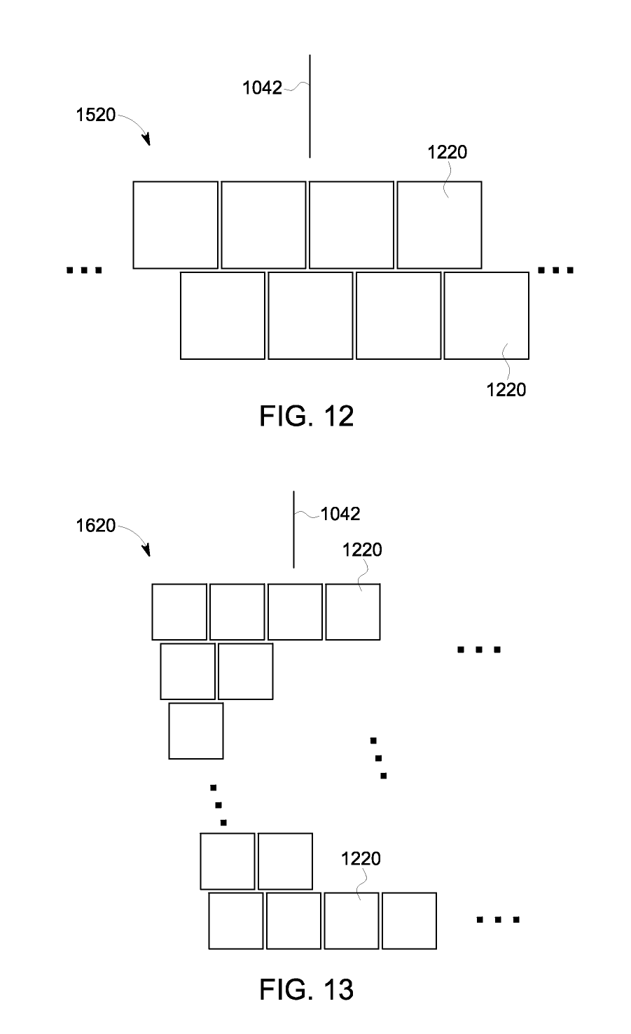

FIG. 12 schematically illustrates detector 1520 for use with radiation source 22, 1022. Detector 1520 comprises a two-dimensional array of two rows of detector units 1220, wherein detector units 1220 of the two rows are staggered or offset with respect to one another. FIG. 13 schematically illustrates detector 1620. Detector 1620 comprises a two-dimensional array of multiple or n-rows of detector units 1220. Like detector units 1220 of detector 1520, detector unit 1220 of detector 1620 are staggered or offset with respect to detector units 1220 of adjacent rows in a direction perpendicular to a scanning direction of the detector. In other words, in the example shown FIG. 8 in which detector 1020 is scanned generally along axis 1042, detector units 1220 are staggered with respect to one another in a direction perpendicular to axis 1042. In one example implementation where the two-dimensional array of the detector has a total of n rows (or staggered columns), such detector units 1220 are staggered with respect to one another within offset of 1/n scintillator pitch. Because such rows have detector units 1220 that are staggered or offset, detectors 1520 and 1620 offer improved image resolution through oversampling, offer better interpolation to account for lost signals and offer better image sampling relative to the size of the individual pixels or detector units, allowing larger pixels or detector units to be utilized while maintaining performance.

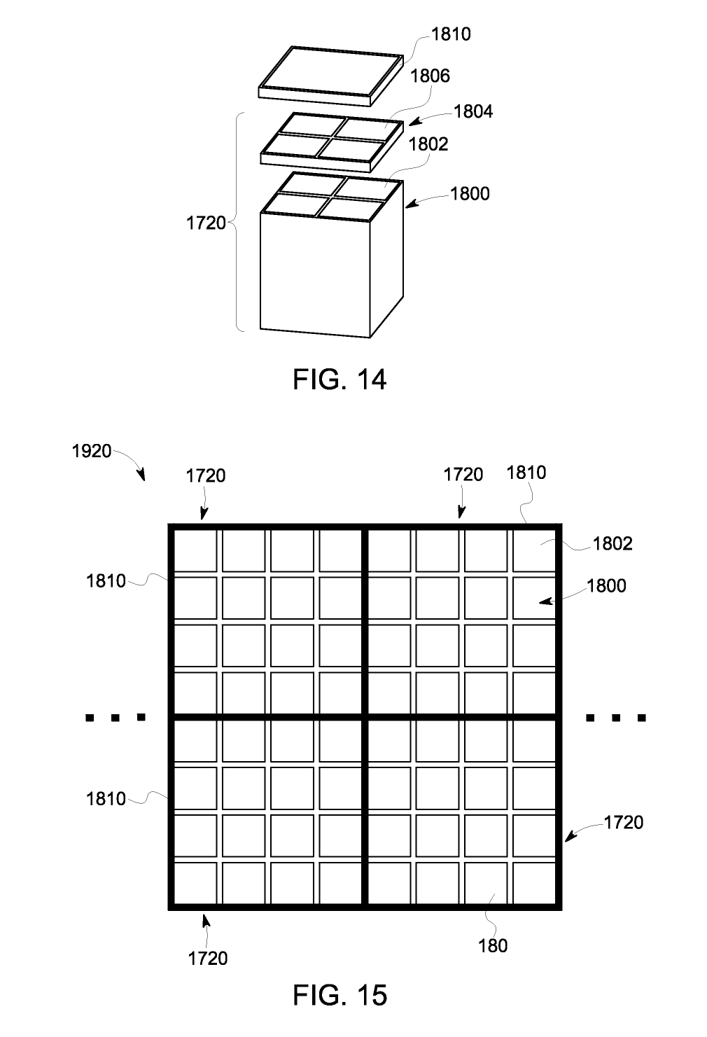

FIG. 14 is an exploded perspective view of detector 1720 for use with radiation source 22, 1022. Detector 1720 comprises scintillator array 1800 of scintillator units 1802, light guide array 1804 of light guide units 1806 and solid-state photomultiplier 1810. Light guide array 1804 of light guide unit 1806 corresponds to scintillator array 1800 of scintillator units 1802. In one implementation, light guide unit 1806 may shift the wavelength of photons emitted from scintillator unit 1802 prior to directing such photons to solid-state photomultiplier 1810 as described above with respect to light guides 525 and light guides 925. Solid-state photomultiplier 1810 receives photons from the plurality of scintillators are scintillator units 1804. As a result, smaller fabricated scintillator units 1804 forming a larger web or wafer of scintillator units 1804 may be cut or otherwise partitioned and utilized with a single solid-state photomultiplier 1810 to reduce cost. In some implementations, detector 1720 may comprise an individual unit of a larger one-dimensional or two-dimensional array of similar units that form an overall detector. In one implementation, the two-dimensional array of similar units may be arranged in staggered or offset rows as described above with respect to detectors 1520 and 1620. FIG. 15 schematically illustrates detector 1920. Detector 1920 comprises a two-dimensional array of two rows of detectors 1720.

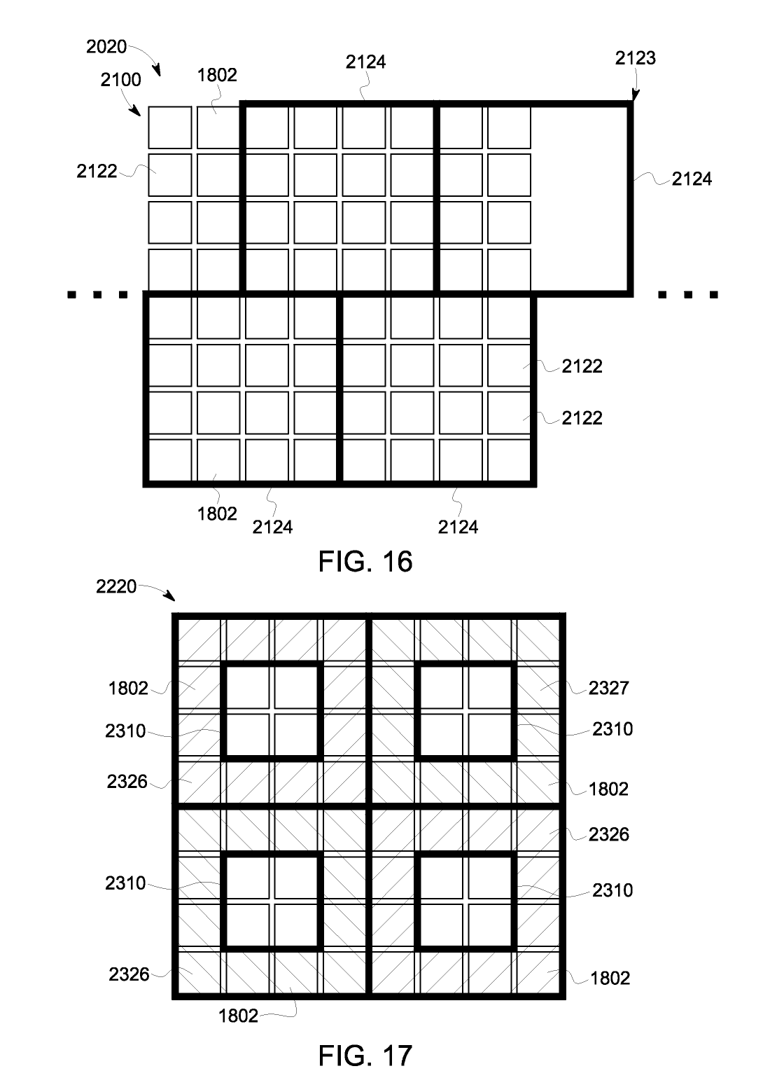

FIG. 16 schematically illustrates detector 2020 for use with radiation source 22, 1022. Detector 2020 comprises a two-dimensional array 2100 of scintillator units or scintillator pixels 2122 and a two-dimensional array 2123 of solid-state photomultiplier units 2124. Array 2123 comprises two or more rows or two or more one-dimensional arrays of solid-state photomultiplier unit 2124 which are staggered or offset with respect to one another. Solid-state photomultiplier units 2124 receive photons from scintillator units 2122. In one implementation, light guides may be operably coupled between scintillator unit 2122 and solid-state photomultiplier units 2124. In some implementations, such light guides may be configured to optically shift the wavelength of the photons emitted by such scintillator unit 2122 prior to the photons being further transmitted to solid-state photomultiplier unit 2124. Because each solid-state photomultiplier units 2124 receive photons from the plurality of scintillators or scintillator units 1804, smaller fabricated scintillator units 2122 forming a larger web or wafer of scintillator units 2122 may be cut or otherwise partitioned and utilized with a single solid-state photomultiplier unit 2124 to reduce cost. Because solid-state photomultiplier units 2124 are arranged in a staggered or offset two-dimensional array, array 2100 offers improved image resolution through oversampling, offers better interpolation to account for lost signals and offers better image sampling relative to the size of the individual pixels or detector units, allowing larger solid-state photomultiplier units 2124 to be utilized while maintaining performance.

FIG. 17 schematically illustrates radiation detector 2220, another implementation of detector 320. Radiation detector 2220 is similar radiation detector 1920 shown in FIG. 15 except that radiation detector 2220 utilizes solid-state photomultipliers 2310 instead of solid-state photomultipliers 1810 and additionally includes optical area constrictors 2326. Solid-state photomultipliers 2310 are similar to solid-state photomultipliers 1810 except that solid-state photomultiplier 2310 have a smaller cross-sectional area for their input and a smaller two-dimensional size facilitated by optical area constrictors 2326.

Optical area constrictors 2327 (shown in crosshatching) are each similar to optical area constrictors 527 shown and described above with respect to FIG. 6. Each optical area constrictor 2327 constricts the cross-sectional optical transmission area between the corresponding grouping of scintillator units 1802 and the single corresponding are associated solid-state photomultiplier 2310. Optical area constrictor 2327 comprises reflective surfaces 530 surrounding or otherwise defining or forming a window 532 through which photons may pass. The reflective surfaces may be formed by coatings of materials that are spectrally opaque to the wavelength of the scintillator light or photons produced by scintillator the grouping of scintillators 1802. In one implementation, the reflective surfaces or reflective surface may be formed by white paint, such as titanium oxide. In other implementations, the reflective faces may be formed by other reflective material such as polytetrafluoroethylene (TEFLON) tape, white plastics, white epoxies, reflective metals, glues and the like.

In the example illustrated, each optical area constrictor 2237 comprises a layer of reflective material forming a window, wherein the layer or coatings are formed directly upon scintillator units 1802. In other implementations, optical area constrictors 2327 may alternatively each comprise a layer or coating of reflective material forming a window, wherein the layer or coating is directly formed upon a single light guide extending from the grouping of scintillator units 1802 or formed upon multiple light guides with each light guide extending from an individual scintillator unit 1802. In some implementations, such light guides may be wavelength shifting light guides as described above. In still other implementations, optical area constrictors 2327 may alternatively be provided by a tapered light guide optically coupled between a grouping of scintillator units 1802 and a single individual solid-state photomultiplier 2310 as described above with respect to optical area constrictor 327 as shown in FIG. 4.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An x-ray absorptiometry apparatus comprising:
a radiation source having a beam opening angle of less than or equal to 30 milliradians in at least one dimension;
a scintillator unit to receive radiation from the radiation source with the beam angle after the radiation has passed through a body being imaged; and
a solid-state photomultiplier to receive photons from the scintillator and to produce electrical signals based on the photons.

2. The apparatus of claim 1, wherein the radiation source has a beam angle of less than or equal to 25 milliradians in at least one dimension.

3. The apparatus of claim 2, wherein the scintillator unit comprises a single channel dual x-ray scintillator.

4. The apparatus of claim 1, further comprising a tapering light guide optically coupled between the scintillator and the solid-state photomultiplier.

5. The apparatus of claim 4, wherein the tapering light guide comprises a wavelength shifting light guide.

6. The apparatus of claim 1 further comprising reflective surfaces forming a window between the scintillator and the solid-state photomultiplier.

7. The apparatus of claim 1, wherein the scintillator unit is part of a one-dimensional array of scintillator units.

8. The apparatus of claim 1, wherein the scintillator unit is part of a two-dimensional array of scintillator units.

9. The apparatus of claim 8, wherein the two-dimensional array comprises adjacent staggered rows of scintillator units.

10. The apparatus of claim 1, wherein the scintillator unit is part of array of scintillator units, the apparatus comprising a plurality of solid-state photomultipliers, including the solid-state photomultiplier, corresponding to the array of scintillator units.

11. The apparatus of claim 1 comprising a plurality of solid-state photomultipliers, including the solid-state photomultiplier, arranged in a two-dimensional array of staggered rows.

12. The apparatus of claim 1, wherein the solid-state photomultiplier is arranged to receive photons from a plurality of scintillators units of the array of scintillator units.

13. A x-ray absorptiometry apparatus comprising:
a plurality of scintillators;
a solid-state photomultiplier receiving photons from the plurality of scintillators.

14. A x-ray absorptiometry apparatus comprising:
a plurality of scintillators; and
a plurality of solid-state photomultipliers receiving photons from the plurality of scintillators, wherein at least one of the plurality of scintillators and the plurality of solid-state photomultipliers is arranged in a two-dimensional array of staggered rows.

15. The apparatus of claim 16, wherein the plurality of scintillators are arranged in a two-dimensional array of staggered rows.

16. The apparatus of claim 16, wherein the plurality of solid-state photomultipliers are arranged in a two-dimensional array of staggered rows.

17. A method comprising:
providing a beam of ionizing radiation having a beam opening angle of less than or equal to 30 milliradians in at least one dimension;
receiving the ionizing radiation that has passed through a body being imaged with an array of scintillator units;
converting absorbed energy in the scintillator units into photons;
receiving the photons with the solid-state photomultiplier to produce an electrical signal.

18. The method of claim 17 further comprising counting photons assigned to each of a plurality of bins based upon signals from the solid-state photomultiplier.

19. The method of claim 17 further comprising measuring a voltage

20. The method of claim 17 comprising:
receiving the ionizing radiation with a plurality of scintillators;
converting absorbed energy into photons with the plurality of scintillators;
receiving the photons from the plurality of scintillators with a single solid-state photomultiplier to produce an electrical signal.

21. A dual energy x-ray system comprising:
a radiation source supplying a beam of ionizing radiation having a beam opening angle of less than or equal to 30 milliradians in at least one dimension;
an array of scintillator units to receive the beam of ionizing radiation energy that is passed through a body being imaged and to produce photons; and
a solid-state photomultiplier to receive the photons from the array of scintillator units to produce an electrical signal.
